(19) United States
(12) Patent Application Publication
(10) Pub. No.: US 2024/0163991 A1
(43) Pub. Date: May 16, 2024

(54) SINGLE STAGE POWER FACTOR CORRECTION CIRCUIT FOR HORTICULTURAL LED LIGHTS

(71) Applicant: INVENT10 LIMITED, Hong Kong (CN)

(72) Inventor: Kam Wah SIU, Hong Kong (CN)

(73) Assignee: INVENT10 LIMITED, Hong Kong (CN)

(21) Appl. No.: 17/985,917

(22) Filed: Nov. 14, 2022

(51) Int. Cl. H05B 45/355; H02M 1/14; H02M 1/42; H02M 7/06

(52) U.S. Cl. CPC H05B 45/355; H02M 1/14; H02M 1/42; H02M 7/06

(57) ABSTRACT

Embodiments of the invention overcome prior approaches by creating a single-stage, high-power LED driver topology. In one aspect, the topology may be used and suitable for driving horticultural LED lights.

### FIELD OF THE INVENTION

Aspects of the invention generally relate to LED control design. More specifically, embodiments of the invention relate to improved circuit configurations for LED lights.

### BACKGROUND

Horticulture technology has involved over the years when consumers' food consumption habits are changing. The health benefits of consumption of vegetables have in focus in recent years, and the businesses are creating different ways to increase yield.

Despite different areas of focus within the science of horticulture, such as olericulture, pomology or fruticulture, floriculture, or the like, most of the focus is on using existing technologies, such as a lighting system, and a sprinkler irrigation system. Further circuitry or power control devices used therein are often off-the-shelf purchase, so the management of the overall system has various shortcomings. In particular, many of the existing implementations for power boost in power supply focus on power regulations for lighting for human visual perceptions. However, such directions may not be applicable in the horticulture business.

### SUMMARY OF THE INVENTION

Embodiments of the invention overcome prior approaches by creating a single-stage, high-power LED driver topology. In one aspect, the topology may be used and suitable for driving horticultural LED lights while reducing costs and weight of the power supply. In a further embodiment, aspects of the invention further improve the longevity of LED lights for horticulture.

### BRIEF DESCRIPTION OF THE DRAWINGS

Persons of ordinary skill in the art may appreciate that elements in the figures are illustrated for simplicity and clarity so not all connections and options have been shown. For example, common but well-understood elements that are useful or necessary in a commercially feasible embodiment may often not be depicted in order to facilitate a less obstructed view of these various embodiments of the present disclosure. It may be further appreciated that certain actions and/or steps may be described or depicted in a particular order of occurrence while those skilled in the art may understand that such specificity with respect to sequence is not actually required. It may also be understood that the terms and expressions used herein may be defined with respect to their corresponding respective areas of inquiry and study except where specific meanings have otherwise been set forth herein.

FIG. 1 is a diagram illustrating a schematic of a circuit design according to one embodiment.

FIGS. 2A to 2B show a set of schematic of an improved rectifier for a power supply unit to at boost power stage for horticulture LED growth light according to one embodiment.

FIG. 3 shows a schematic of an improved PFC controller for a power supply unit of FIGS. 2A to 2B according to one embodiment.

FIG. 4 shows a schematic of an improved 0-10V dimming circuit for a power supply unit of FIGS. 2A to 2B according to one embodiment.

FIGS. 5-8 show a set of schematic of a buck PFC power supply unit at a buck power stage for horticulture LED growth light according to one embodiment.

### DETAILED DESCRIPTION

Embodiments may now be described more fully with reference to the accompanying drawings, which form a part hereof, and which show, by way of illustration, specific exemplary embodiments which may be practiced. These illustrations and exemplary embodiments may be presented with the understanding that the present disclosure is an exemplification of the principles of one or more embodiments and may not be intended to limit any one of the embodiments illustrated. Embodiments may be embodied in many different forms and should not be construed as limited to the embodiments set forth herein; rather, these embodiments are provided so that this disclosure may be thorough and complete, and may fully convey the scope of embodiments to those skilled in the art. Among other things, the present invention may be embodied as methods, systems, computer readable media, apparatuses, or devices. Accordingly, the present invention may take the form of an entirely hardware embodiment, an entirely software embodiment, or an embodiment combining software and hardware aspects. The following detailed description may, therefore, not to be taken in a limiting sense.

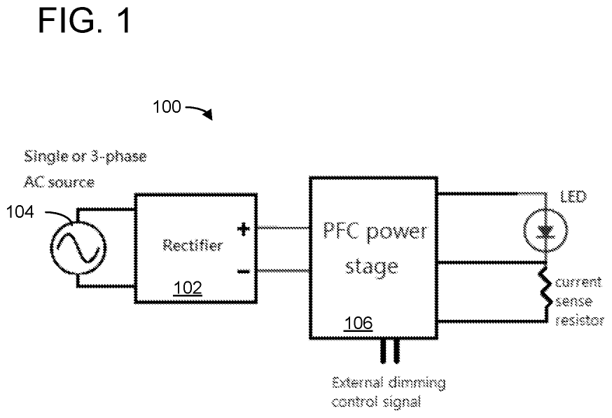

It is known that a typical AC/DC power supply is made up of several circuits that transform an input AC voltage into a stable DC voltage at the output. Referring to FIG. 1, a schematic of a circuit design 100 according to one embodiment. In one embodiment, the circuit design 100 may include a rectifier 102 for transforming the AC voltage into a DC voltage. In one aspect, the rectifier 102 alone may not be enough to ensure adequate operation. In one aspect, in order for an AC/DC power source 104 to be efficient and safe, aspects of the invention may incorporate a power factor correction (PFC) stage 106. In one embodiment, the rectifier 102 may rectify the input voltage. In another aspect, the rectifier 102 may convert single phase or 3-phase AC voltage into ripple DC voltage. In one embodiment, the PFC stage 106 may smooth the DC ripple and regulate the LED current. Contrary to existing power supply for LED lights, a current smooth device is likely disposed between the PFC power stage and the LED lights in order to reduce the effects of the ripple, which may be perceived by human as flickering effect on lighting. In other words, aspects of the invention eliminate the need for such device but still able to reduce the ripple effect coming from a single or 3-phase AC source.

In another embodiment, a number of circuit topologies for the PFC stage 106 may be used to build the PFC power stage. In one example, Table 1 lists some topologies and the criteria to use them.

| | Output voltage | | |
|---|---|---|---|
| | (Vout) and input | | |
| PFC | voltage (Vin) | | Efficiency |
| stage | relationship | Isolated or not | comparison |
| Boost | Vout > Vin | Non-isolated | Highest |
| Buck | Vout < Vin | Non-isolated | Very high |
| Buck-boost | Vout is negative | Non-isolated | High |
| Sepic | Vout is positive | Non-isolated | High |
| Cuk | Vout is negative | Non-isolated | High |
| Flyback | Any Vout | Isolated | Average |

In one embodiment, using a single-stage for the PFC stage 106 as an example, power conversion and regulation may eliminate the penalty associated with a second stage power conversion. In another embodiment, for horticultural lights, the low frequency LED current ripple of single-stage is acceptable, contrary to human visual perception. As such, dimming control range may be from output completely off to full maximum output current.

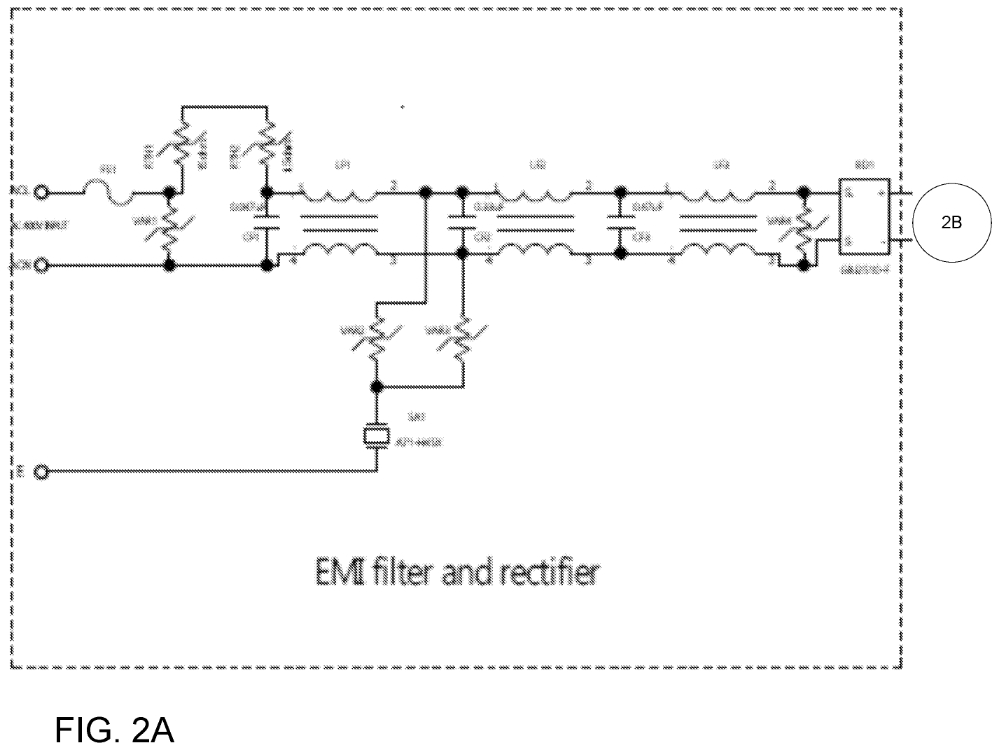

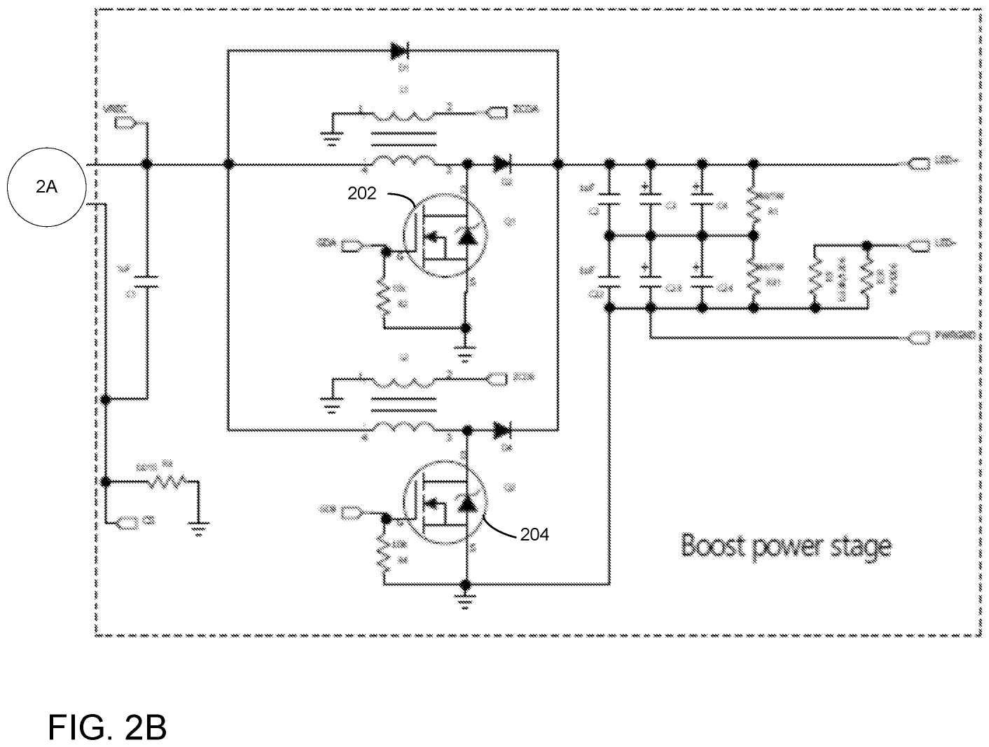

In another embodiment, the PFC stage 106 having the stage configuration as shown above may be used. In one aspect, the PFC stages may be boost and buck stage as identified above and as shown in FIGS. 2A to 8. For example, a power supply unit (PSU) incorporating the circuit design 106 may be suitable for horticulture LED lighting fixtures without any additional current smoothing device disposed between the PFC stage 106 and the LED lights.

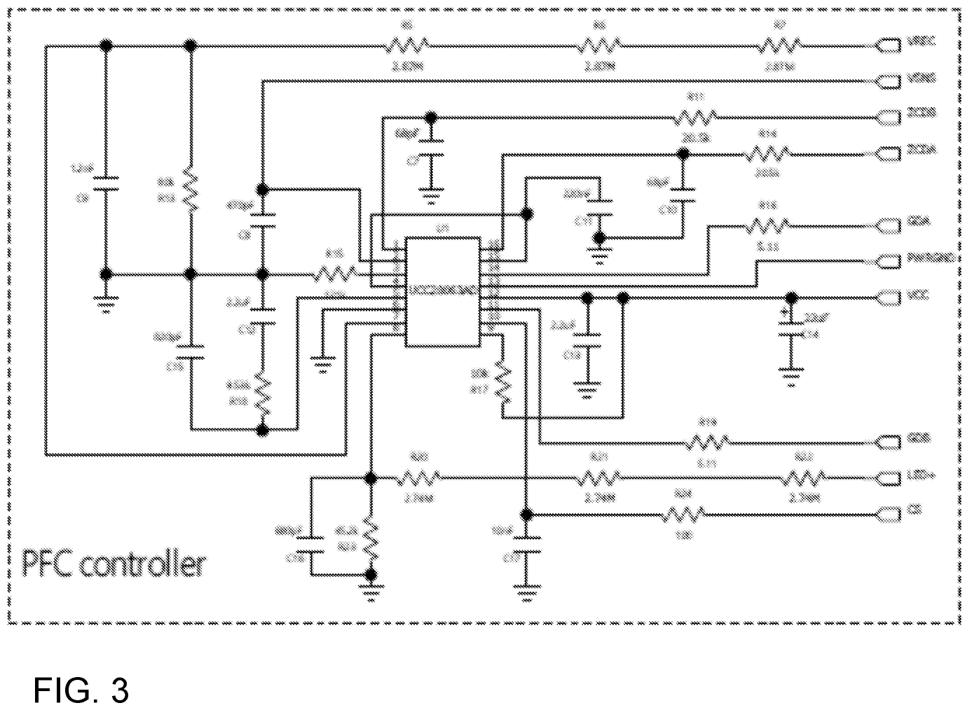

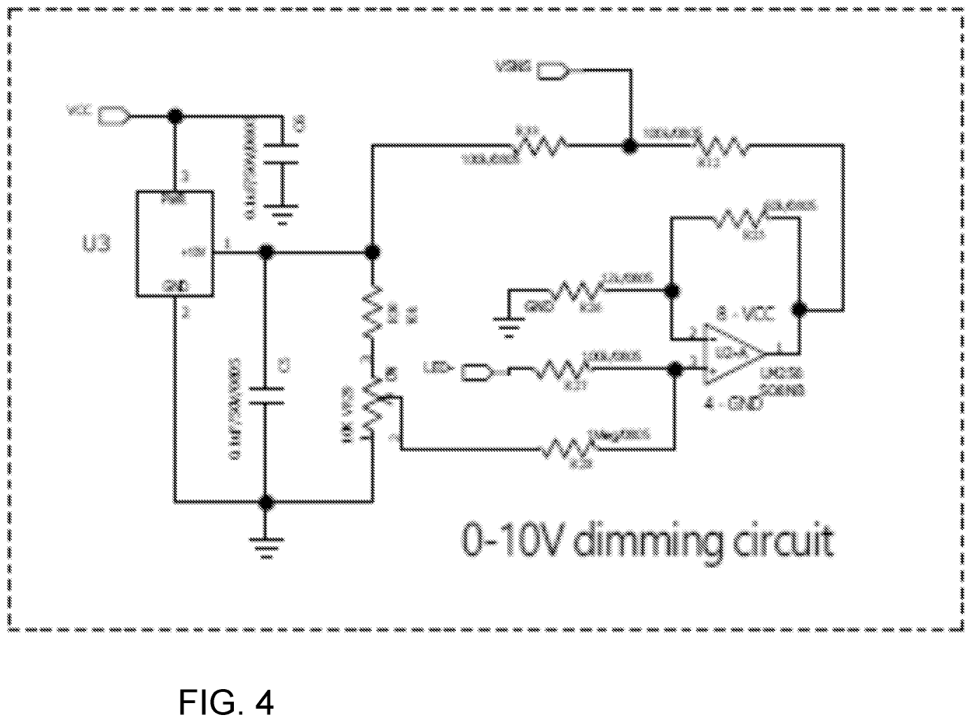

Referring to FIGS. 2A and 2B, a set of schematic circuits shows an improved circuitry in a boost power stage for a power supply unit according to one embodiment. In one embodiment, the circuits in FIGS. 2A and 2B may be connected to a PFC controller in FIG. 3 and a 0-10V dimming circuit show in FIG. 4 to form circuit blocks of the power supply unit. For example, FIGS. 2A to 4 illustrate an interleaved boost PFC power supply unit for one or more LED growth light. In one example, FIGS. 2A to 4 illustrate a combination that may be packaged as a power supply unit capable of driving 740V DC to 840V DC LED, 1000 W DC output that operates from an input voltage of 360 Vrms to 440 Vrms and provides power-factor correction. In a further embodiment, the circuits in FIGS. 2A to 4 provide interleaving control and provide benefits such as reduced ripple currents and reduced electromagnetic interference (EMI) filter using two metal-oxide-semiconductor field-effect (MOSFET) transistors or inductors 202 and 204 in FIG. 2B. With the MOSFET transistors 202 and 204, the interleaving effect may be accomplished when one MOSFET transistor 202 is turned on and the other MOSFET transistor 204 is turned off and vice versa.

In one aspect, the circuits of FIGS. 2A to 4 may enable a realization of a higher efficiency in powering the one or more LED lights by splitting the output current into two paths, substantially reducing conduction losses and inductor AC losses through the interleaving effect from the MOSFET transistors 202 and 204. In one example, the full load efficiency is about 97% at 400 Vrms input.

In a further embodiment, this configuration may able to achieve the boost stage while reducing current ripple and EMI without using any additional device or filter disposed between the PFC unit 106 and the LED lights for horticulture applications. In another application example, LED lights for other non-human usage or application, such as for fish farming, etc., where long exposure to lighting may be used without affecting human visual impairment or discomfort, the PSU incorporating aspects of the invention may be beneficial over the existing PSU for LED or other lighting devices.

In yet another embodiment, the circuitry of the PSU illustrated in FIGS. 2A to 4 may regulate or permit about 15% of ripple effect caused or introduced by electrical current from the single or 3-phase AC power source

In one example, the power supply unit (PSU) may include four circuit blocks: the EMI filter and rectifier in FIG. 2A, the boost power stage in FIG. 2B, the PFC controller in FIG. 3 and the 0-10V dimming circuit in FIG. 4. In one aspect, only one power stage may be used or illustrated in the PSU which may eliminate the extra cost for a second power stage and the associated EMI filters and efficiency drop.

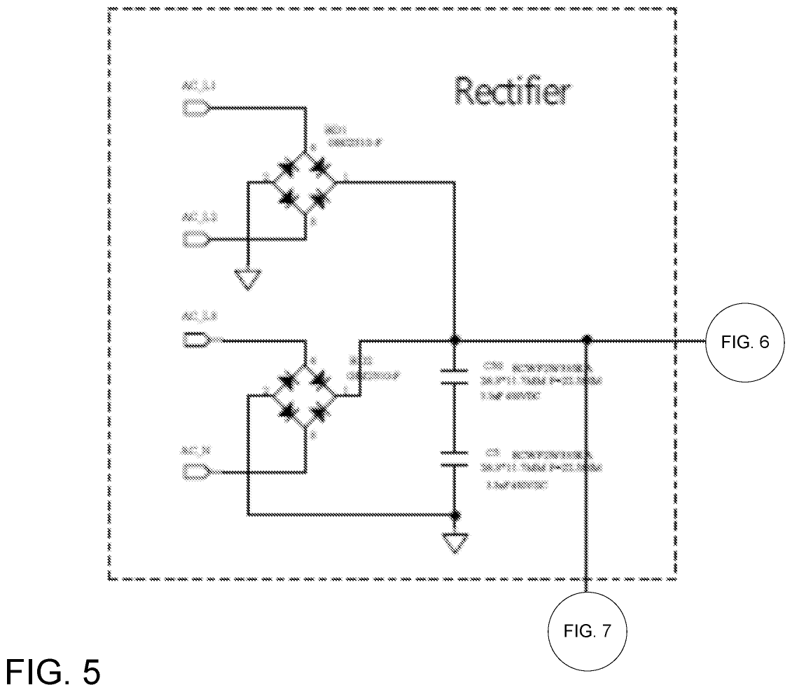

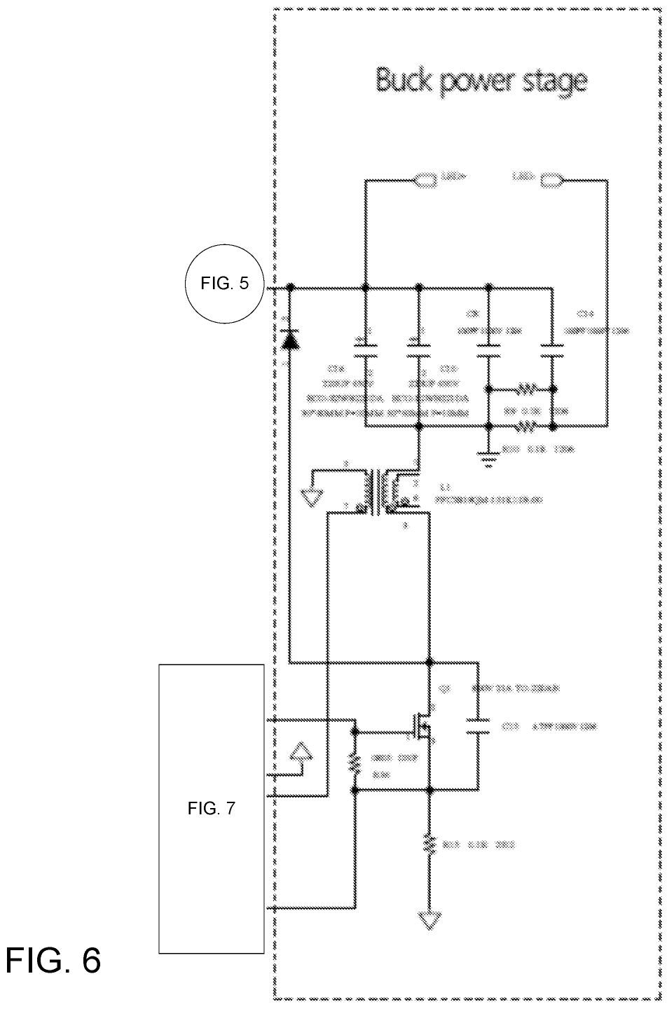

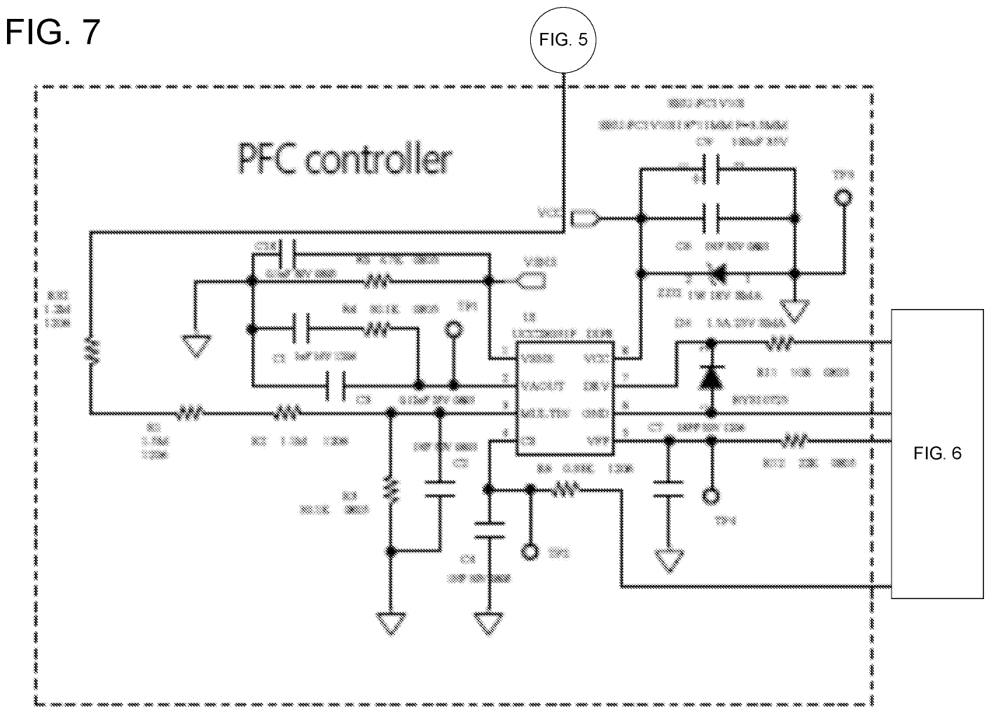

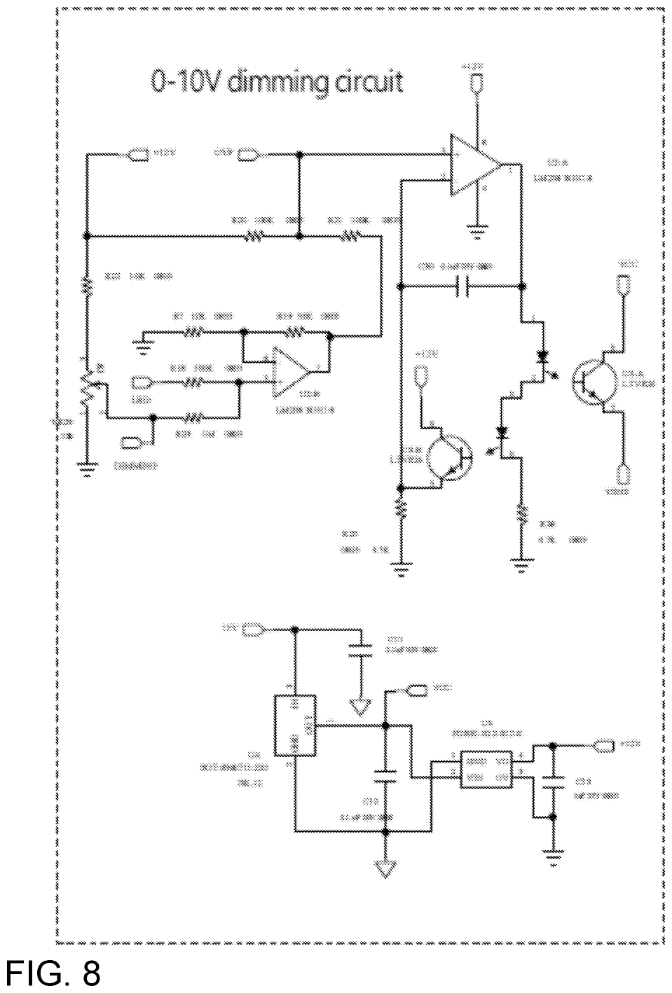

In another aspect, FIGS. 5-8 illustrate a set of schematics of a buck PFC power supply unit for a LED growth light according to one embodiment. In one aspect, FIGS. 5-8 illustrate circuit schematics for an improved power supply unit (PSU) capable of driving 280 VDC to 360 VDC LED, 1000 W DC output that operates from a 3-phase input voltage of 360 Vrms to 440 Vrms and provides power-factor correction. In one aspect, the power supply unit may include 4 circuit blocks: the rectifier in FIG. 5, the buck power stage in FIG. 6, the PFC controller in FIG. 7 and the 0-10V dimming circuit in FIG. 8. In a further embodiment, a full rectification from a 3-phase input voltage source may provide an average DC voltage of 1.35 times the value of the input root mean square (RMS) voltage. In a further aspect, a 400 VRMS 3-phase input voltage may give a 540 VDC rectified DC voltage. As such, the buck power stage may work as a DC-DC power conversion which requires smaller output bulk capacitor and converts more efficiently. In one aspect, the full load efficiency may be about 98% at 400 VRMS 3-phase input.

It may be understood that the present invention as described above may be implemented in the form of control logic using computer software in a modular or integrated manner. Based on the disclosure and teachings provided herein, a person of ordinary skill in the art may know and appreciate other ways and/or methods to implement the present invention using hardware, software, or a combination of hardware and software.

The above description is illustrative and is not restrictive. Many variations of embodiments may become apparent to those skilled in the art upon review of the disclosure. The scope embodiments should, therefore, be determined not with reference to the above description, but instead should be determined with reference to the pending claims along with their full scope or equivalents.

One or more features from any embodiment may be combined with one or more features of any other embodiment without departing from the scope embodiments. A recitation of “a”, “an” or “the” is intended to mean “one or more” unless specifically indicated to the contrary. Recitation of “and/or” is intended to represent the most inclusive sense of the term unless specifically indicated to the contrary.

One or more of the elements of the present system may be claimed as means for accomplishing a particular function. Where such means-plus-function elements are used to describe certain elements of a claimed system it may be understood by those of ordinary skill in the art having the present specification, figures and claims before them, that the corresponding structure includes a computer, processor, or microprocessor (as the case may be) programmed to perform the particularly recited function using functionality found in a computer after special programming and/or by implementing one or more algorithms to achieve the recited functionality as recited in the claims or steps described above. As would be understood by those of ordinary skill in the art that algorithm may be expressed within this disclosure as a mathematical formula, a flow chart, a narrative, and/or in any other manner that provides sufficient structure for those of ordinary skill in the art to implement the recited process and its equivalents.

While the present disclosure may be embodied in many different forms, the drawings and discussion are presented with the understanding that the present disclosure is an exemplification of the principles of one or more inventions and is not intended to limit any one embodiments to the embodiments illustrated.

The present disclosure provides a solution to the long-felt need described above. In particular, aspects of the invention provide an automated processing and generation a compliance document for filing on behalf of a registered entity, wherein the compliance document complies with government regulated formats and contents.

Further advantages and modifications of the above described system and method may readily occur to those skilled in the art.

The disclosure, in its broader aspects, is therefore not limited to the specific details, representative system and methods, and illustrative examples shown and described above. Various modifications and variations may be made to the above specification without departing from the scope or spirit of the present disclosure, and it is intended that the present disclosure covers all such modifications and variations provided they come within the scope of the following claims and their equivalents.

What is claimed is:

1. A power supply unit for non-human application setting comprising:
a rectifier disposed between a single or three-phase alternating current (AC) power source and a power factor correction (PFC) stage unit;
wherein the rectifier is configured to convert AC voltage into direct current (DC) ripple voltage; and
wherein the PFC stage unit is disposed between the rectifier and a light emitting diode (LED).

2. The power supply unit of claim 1, wherein the PFC stage unit is configured to smooth a DC ripple current.

3. The power supply unit of claim 1, wherein the PFC stage unit is configured to regulate a current fed into the LED.

4. The power supply unit of claim 2, wherein the PFC stage unit is configured to smooth the DC ripple current independent of a DC current regulating device disposed between the PFC stage unit and the LED.

5. The power supply unit of claim 4, wherein the PFC stage unit is configured to regulate the current fed into the LED independent of the DC current regulating device disposed between the PFC stage unit and the LED.

6. A power supply unit for horticulture lighting application setting comprising:
a rectifier disposed between a single or three-phase alternating current (AC) power source and a power factor correction (PFC) stage unit;
wherein the rectifier is configured to convert AC voltage into direct current (DC) ripple voltage; and
wherein the PFC stage unit is disposed between the rectifier and a light emitting diode (LED) disposed in a horticulture setting.

7. The power supply unit of claim 6, wherein the PFC stage unit is configured to smooth a DC ripple current.

8. The power supply unit of claim 6, wherein the PFC stage unit is configured to regulate a current fed into the LED.

9. The power supply unit of claim 7, wherein the PFC stage unit is configured to smooth the DC ripple current independent of a DC current regulating device disposed between the PFC stage unit and the LED.

10. The power supply unit of claim 9, wherein the PFC stage unit is configured to regulate the current fed into the LED independent of the DC current regulating device disposed between the PFC stage unit and the LED.

11. A system for horticulture lighting application setting comprising:
a rectifier disposed between a single or three-phase alternating current (AC) power source and a power factor correction (PFC) stage unit;
wherein the rectifier is configured to convert AC voltage into direct current (DC) ripple voltage; and
wherein the PFC stage unit is disposed between the rectifier and a light emitting diode (LED) disposed in a horticulture setting.

12. The power supply unit of claim 11, wherein the PFC stage unit is configured to smooth a DC ripple current.

13. The power supply unit of claim 11, wherein the PFC stage unit is configured to regulate a current fed into the LED.

14. The power supply unit of claim 12, wherein the PFC stage unit is configured to smooth the DC ripple current independent of a DC current regulating device disposed between the PFC stage unit and the LED.

15. The power supply unit of claim 14, wherein the PFC stage unit is configured to regulate the current fed into the LED independent of the DC current regulating device disposed between the PFC stage unit and the LED.
